(19) United States
(12) Patent Application Publication
(10) Pub. No.: US 2020/0138036 A1
(43) Pub. Date: May 7, 2020

(54) FUMIGANT FORMULATION

(71) Applicant: Linde Aktiengesellschaft, Munich (DE)

(72) Inventors: Ernst MIKLOS, Kirchheim (DE); Wilhelm BAYERL, Sauerlach (DE); Silvia HENKE, Bernried (DE); Laura GARCIA ALBA, Munich (DE); Saskia HUBER, Karlsfeld (DE)

(73) Assignee: Linde Aktiengesellschaft, Munich (DE)

(21) Appl. No.: 16/607,470

(22) PCT Filed: Apr. 13, 2018
(86) PCT No.: PCT/EP2018/025116

§ 371 Date: Oct. 23, 2019

(30) Foreign Application Priority Data
Apr. 24, 2017 (EP) 17020161.0

(51) Int. Cl. A01N 59/02; A01N 31/02; A01N 29/02; A01N 43/88; A01N 33/18; A01N 47/40

(52) U.S. Cl. CPC A01N 59/02; A01N 31/02; A01N 47/40; A01N 43/88; A01N 33/18; A01N 29/02

(57) ABSTRACT

The invention relates to a fumigant formulation comprising a mixture of ethyl formate dissolved in supercritical carbon dioxide.

The present invention relates to a fumigant formulation comprising a mixture of a fumigant active ingredient and carbon dioxide and to its use, as well as to a method and a device for providing a mixture of a fumigant active ingredient and CO2.

Ethyl formate is a fumigant which is currently registered as a pesticide in Australia. It is considered to be a safer and more environmentally-friendly alternative to fumigants such as methyl bromide. It is classified as a low risk GRAS (generally recognised as safe) food additive and is easily hydrolysed to acceptable bi-products ethanol and formic acid.

Ethyl formate can be used as fumigant, treating agricultural crops (grains, fruits, vegetables, etc.), food products, or any material goods (furniture, rooms, buildings, etc.) against different pests. It is therefore also considered a pesticide. Studies exist, which indicate also suitability for herbicide type of applications.

Ethyl formate is a volatile compound. It has a boiling point of 54.3° C., a vapour pressure of 25.9 kPa at 20° C. and a low flash point. It is also highly flammable in its liquid state which may pose handling risks. However, the flammability of ethyl formate can be reduced by combining it with carbon dioxide (CO2) or another diluent. It has been found that ethyl formate mixed with CO2 not only retains its efficacy as a fumigant but may also have increased efficacy (see WO 03/061384).

Such a mixture of ethyl formate and CO2 is currently supplied in cylinders, containing ethyl formate C3H6O2 (HCOOC2H5) as active substance dissolved in liquid CO2. The ratio is 16.7% by weight, 11% by volume of ethyl formate (short ETF) in balance with CO2. A typical cylinder pressure is 6300 KPa/63 bar (vapor pressure).

Regardless for what the product is used, the current procedure foresees to withdraw liquid CO2-ETF mixture from the cylinder via a dip tube from the cylinder, and to subsequently evaporate the mixture, to apply it then in gaseous form to the subject of treatment. A portable electric vaporator for vaporising a CO2-ETF-mixture is disclosed in EP 2681993 A1.

During the withdrawal of the CO2-ETF-mixture from the cylinder the concentration of ETF in CO2 might change. Depending on the extracted and/or remaining liquid in the cylinder and on the liquid/vapour ratio, the concentration might vary especially at the emptier cylinder stage. This can lead to a higher ETF concentration in CO2 at the end of the cylinder emptying process which can negatively impact the product (fruit, vegetable, etc.). Further, too high ETF concentrations will increase the risk of flammability, as ETF is a highly flammable substance. So if for example a cylinder is emptied to more than 80% the ratio of ETF in the liquid CO2 can raise up to 40%.

One method to avoid these risks is to continuously measure the weight of the cylinder during the emptying process and to stop withdrawal of product once a critical level (eg 20% remaining liquid) is reached. Beyond that critical level of liquid in the cylinder, the concentration of ETF in the mixture is too high and the remaining product cannot be used anymore. However, this method brings additional complexity to the application, as the cylinder needs to be placed on a scale during use. Further, the cylinder with the remaining liquid has to be handled carefully as the residual gas is highly flammable and needs to be disposed safely and adequately.

It is an object of the present invention to provide a fumigant formulation and a method and a device for providing a fumigant formulation which avoids the above-mentioned drawbacks.

The object is achieved by a fumigant formulation comprising a mixture of a fumigant active ingredient and carbon dioxide, characterized in that the active ingredient is dissolved in supercritical carbon dioxide (CO2), which is acting as diluent for the fumigant active ingredient.

It has been found that by dissolving a fumigant active ingredient in supercritical carbon dioxide the concentration of the active ingredient does not change when a portion of the mixture is withdrawn. The active ingredient does completely dissolve in the supercritical carbon dioxide and its concentration will stay constant.

Ethyl formate (ETF) is an eco-friendly fumigant active ingredient and thus especially preferred. Other active ingredients which can be used within the scope of the present invention are ethyl formate, 1,3-dichloropropene, dazomet (methyl isothiocyanate precursor), chloropicrin, iodoform, methyl isocyanate and/or sulfuryl fluoride.

Preferably, 3 to 15% by volume or 5 to 10% by volume of the fumigant active ingredient, especially ethyl formate, is dissolved in the supercritical CO2. An ETF concentration below 15% by volume does not raise any long-term residual concerns for fumigated commodities. A fumigant formulation with an ETF concentration of below 10% by volume is non-flammable and thus it is in particular preferred.

The inventive fumigant formulation is preferably used as a pesticide or as a biocide. It can be used to treat for example crops, fruits, vegetables, grains, or to treat any other infested matter, such as buildings, vessels, furniture or mats.

The invention further relates to a method to provide a mixture of a fumigant active ingredient and CO2, which is characterized in that the mixture of the fumigant active ingredient and CO2 is heated in a closed container to a temperature at which the CO2 becomes supercritical. The critical temperature of CO2 is about 31° C. Thus, the temperature of the mixture is at least increased to a temperature preferably between 31 to 55° C. or higher or more prefered between 35 to 50° C.

In a preferred embodiment the mixture of the fumigant active ingredient and CO2 is heated until the fumigant active ingredient is completely dissolved in the supercritical CO2. Thereby, it is ensured that the concentration of the fumigant active ingredient will remain the same and that it will not change when the container with the mixture is emptied.

In another embodiment the mixture of the fumigant active ingredient and CO2 is heated in a container, especially in a gas cylinder, and the pressure of a portion of the heated mixture of the fumigant active ingredient and CO2 is reduced and thereby that portion of the mixture is transferred into its gaseous state.

The term “container” shall mean any vessel, reservoir, receptable, tank, cylinder or similar for receiving and/or storing the mixture of the fumigant active ingredient and CO2.

According to the invention, a liquid mixture of the fumigant active ingredient and CO2 is heated to a temperature above the critical temperature of CO2, that is to a temperature of more than 31° C. Under equilibrium conditions the pressure will also increase until the critical point is reached. Then, the CO2 changes to its super-critical state.

Heating of the container is preferably achieved by means of an eletrical heater, for example by a heating jacket which is arranged in contact with the outer surface of the container. The heating jacket heats up the container and thereby the mixture inside the container. The invention is not limited to the use of a heating jacket or of electrical heating means. Other heating means or heat sources could also be used. But electrical heating is preferred. Further, it is preferred to heat the mixture by indirect heat transfer, that is the mixture is not in direct contact with the heat source.

A preferred use of the inventive fumigant formulation is the treatment of infested matter and/or the pest treatment. Infested matter could be buildings, vessels, furniture or mats. Pest treatment shall in particular include the treatment of crops, fruits, vegetables, grains and so on.

The invention also relates to device for providing a mixture of a fumigant active ingredient and CO2 comprising a container to receive the mixture of the fumigant active ingredient and CO2. The device is characterized in that the container is in heat transfer contact with heating means, especially with a heating jacket or a heating mat. Preferably, a gas cylinder is used as container.

The inventive fumigant formulation is preferably applied by the inventive device. When the fumigant formulation is transferred from the container to the point of use the pressure has to be reduced and there is a risk that solids are formed during the adiabatic expansion of the supercritical mixture. Thus, it is preferred to apply the fumigant formulation from the container or cylinder through a pressure release valve or through a pressure regulator connected to the container at a slightly elevated but controlled temperature. This elevated temperature is necessary to avoid solid formation in the pressure regulator or in the pressure release valve or in a subsequently used pipe.

In another preferred embodiment the heating means comprise a temperature control system. Preferably the pressure regulator and/or pressure release valve are connected to the temperature control system and the pressure release valve is only opened when a pre-defined temperature of the mixture has been reached. Thereby, it is ensured that the mixture is in the super-critical state before being released from the container.

It is also possible to use a smart valve which already indicates the temperature of the mixture and whether it has reached its super-critical state. Such a smart valve may also be provided with means to collect, store and/or document data such as temperature and pressure of the mixture or amount of withdrawn fumigant formulation.

It is further preferred to use a heated pipe between the container with the fumigant formulation and the point of use or between the pressure regulator or the pressure release valve and the point of use. Thereby, constant conditions are guaranteed and solid formation is prevented. Further, a higher fumigation efficacy can be achieved because some active ingredients, for example ethyl formate, work better as pesticide or as biocide at higher temperatures.

The invention has several advantages:
The concentration of the active ingredient does not change when a portion of the mixture is withdrawn. In particular, the active ingredient will not be enriched with time. For example, when ETF is used as active ingredient an increase of flammibility due to enrichment of ETF in carbon dioxide is avoided.
The constant concentration of fumigant ensures that the treated objects, for example crop, is not damaged by an over-dosis of fumigant.
The inventive system is user-friendly and easy to use.
There is no need for a sophisticated vaporizer to vaporize the mixture.

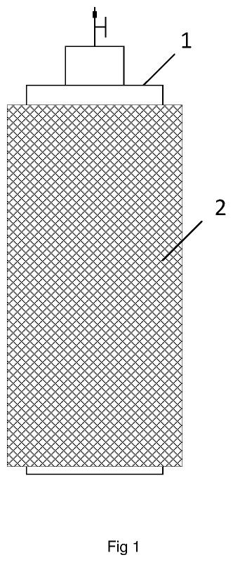

FIG. 1 shows one example for a device for providing a mixture of fumigant active ingriedient and supercritical CO2. The fumigant active igriedient and CO2 are filled into the cylinder 1. The cylinder 1 is covered by a heating jacket 2. If fumigant should be taken out of the cylinder 1, the cylinder 1 is heated to 35 to 50° C. with the heating jacket. Therefore, the CO2 is transferred into a supercritical state and the fumigant active ingredient is dissolved homogenously in the supercritical CO2.

1. Fumigant formulation comprising a mixture of a fumigant active ingredient and carbon dioxide, characterized in that the active ingredient is dissolved in supercritical carbon dioxide (CO2), which is acting as diluent for the fumigant active ingredient.

2. Fumigant formulation according to claim 1, characterized in that the fumigant active ingredient is selected from the group of: ethyl formate, 1,3-dichloropropene, dazomet (methyl isothiocyanate precursor), chloropicrin, iodoform, methyl isocyanate, sulfuryl fluoride.

3. Fumigant formulation according to claim 2 characterized in that the mixture consists of ethyl formate in a concentration of 3-15% by volume or 5-10% by volume, dissolved in CO2.

4. A fumigant formulation according to claim 1, wherein said formulation is a pesticide or a biocide.

5. Method to provide a mixture of a fumigant active ingredient and CO2, characterized in that the mixture of the fumigant active ingredient and CO2 is heated in a closed container to a temperature at which the CO2 becomes supercritical.

6. Method according to claim 5, characterized in that the fumigant active ingredient is selected from the group of: ethyl formate, 1,3-dichloropropene, dazomet (methyl isothiocyanate precursor), chloropicrin, iodoform, methyl isocyanate, sulfuryl fluoride.

7. Method according to claim 5, characterized in that the mixture of the fumigant active ingredient and CO2 is heated to a temperature preferably between 31 to 55° C. or higher or prefered between 35 to 50° C.

8. Method according to claim 5, characterized in that the mixture of the fumigant active ingredient and CO2 is heated until the fumigant active ingredient is completely dissolved in the supercritical CO2.

9. Method according to claim 5, characterized in that the mixture of the fumigant active ingredient and CO2 is heated in a container, especially in a gas cylinder, and that the pressure of a portion of the heated mixture of the fumigant active ingredient and CO2 is reduced and that the mixture is thereby transferred into its gaseous state.

10. Method according to claim 9, characterized in that the container is heated by electrical means, in particular by means of a heating jacket.

11. Method according to claim 9, characterized in that the mixture in the gaseous state is used for treatment of infested matter and/or for pest treatment.

12. Device for providing a mixture of a fumigant active ingredient and supercritical CO2 comprising a container to receive the mixture of the fumigant active ingredient and CO2, characterized in that the container is in heat transfer contact with heating means, especially with a heating jacket.
